(19) United States
(12) Patent Application Publication
(10) Pub. No.: US 2022/0397276 A1
(43) Pub. Date: Dec. 15, 2022

(54) SYSTEM AND METHOD FOR TESTING AN OPERATION OF A GAS HOUSEHOLD COOKING APPLIANCE

(71) Applicants: BSH Home Appliances Corporation, Irvine, CA (US); BSH Hausgeräte GmbH, Munich (DE)

(72) Inventors: Robert Burton, Jacksboro, TN (US); Donnie Smith, Andersonville, TN (US); Claude Wilson, Jacksboro, TN (US)

(21) Appl. No.: 17/342,777

(22) Filed: Jun. 9, 2021

(51) Int. Cl. F24C 3/12; F24C 3/08; G01J 5/12; G01J 5/00; G01J 5/02; F24C 3/02

(52) U.S. Cl. CPC F24C 3/128; F24C 3/087; G01J 5/12; G01J 5/0018; G01J 5/0044; G01J 5/0265; F24C 3/027

(57) ABSTRACT

A system and method are provided for performing a test operation of a gas household cooking appliance having an oven cavity and a gas burner within the oven cavity. The system and method include an infrared thermocouple configured to be portably and temporarily positioned within the oven cavity and configured to produce an output signal in response to a change in temperature within the oven cavity to confirm that the gas burner has ignited. A control unit is configured to execute the test operation only upon receipt of the output signal from the infrared thermocouple within a predetermined amount of time following an initiation of a gas flow to the gas burner.

### FIELD OF THE INVENTION

The present invention is directed to a system for, and method of, testing an operation of a household cooking appliance, and more particularly, to a system for, and method of, confirming that a gas burner of a gas cooking appliance has ignited prior to executing a test operation of a gas household cooking appliance. The system for, and method of, performing a test operation of a gas household cooking appliance includes an infrared thermocouple configured to produce an output signal in response to a change in temperature within the oven cavity to thereby confirm that the gas burner has ignited, and a control unit configured to execute the test operation only upon receipt of the output signal from the infrared thermocouple within a predetermined amount of time following an initiation of a gas flow to the gas burner of the gas household cooking appliance.

### BACKGROUND OF THE INVENTION

A conventional gas home cooking appliance can include, for example, a stand-alone or wall-mounted gas oven or a range having a gas oven. Such gas home cooking appliances commonly are subject to industry standards and regulations related to testing, inspection, and certification.

### SUMMARY OF THE INVENTION

The present invention recognizes that industry standards and regulations related to testing, inspection, and certification of gas cooking appliances by various organizations, such as the CSA Group, may mandate that a flame of a gas cooking appliance be ignited within a predetermined time (e.g., within several seconds) after a flow of gas to the burner has been initiated for testing purposes, which may require an operator to visually observe whether the flame of the gas cooking appliance has been ignited after the flow of gas to the gas burner has been initiated (i.e., turned ON). The present invention further recognizes that physical observation by an operator of whether the flame has ignited may be susceptible to reliability issues, error, etc., which may increase a risk of, or result in, unreliable or inaccurate test results, and hence, a more reliable system for, and method of, ensuring that a burner of a gas cooking appliance is ignited within a predetermined time defined by the specified standard is needed.

To solve these and other problems, the present invention provides a system for, and method of, confirming that a gas burner of a gas cooking appliance has ignited prior to executing a test operation of a gas household cooking appliance, for example, for compliance with industry standards or regulations related to testing, inspection, and certification, and executing the test operation only upon confirming that the gas burner has ignited within a predetermined amount of time following an initiation of a gas flow to the gas burner. In other words, the system and method can be configured to suspend or prevent (e.g., automatically suspend or prevent) any further test operations from proceeding in stances in which ignition of the gas burner has not occurred within a predetermined amount of time following an initiation of a gas flow to the gas burner.

In this way, the present invention can eliminate a need for an operator/tester to physically inspect or view the flame to determine whether the oven burner has ignited and ensure that a burner of the gas cooking appliance has ignited within a predetermined time defined by one or more specified industry standards or regulations related to testing, inspection, and certification, thereby improving reliability and repeatability of the testing procedures and test results.

Particularly, an exemplary embodiment of the invention is directed to a system for performing a test operation of a gas household cooking appliance having an oven cavity and a gas burner within the oven cavity. In this example, the system includes an infrared thermocouple configured to be portably and temporarily positioned within the oven cavity. The infrared thermocouple is configured to produce an output signal in response to a change in temperature within the oven cavity to thereby confirm that the gas burner has ignited and a control unit in communication with the infrared thermocouple. The control unit is configured to execute the test operation only upon receipt of the output signal from the infrared thermocouple within a predetermined amount of time following an initiation of a gas flow to the gas burner.

In some examples, the system includes a jig configured to portably and temporarily support the infrared thermocouple within the oven cavity. The jig can be configured to support the infrared thermocouple at a first predetermined distance above a floor of the oven cavity and/or at a second predetermined distance away from a sidewall of the oven cavity.

In an example, the jig includes a body and a handle extending from the body. The body can include a base configured to rest on a floor of the oven cavity and a support portion configured to support the infrared thermocouple at a first predetermined distance above the floor of the oven cavity when the base rests on the floor. In some examples, the support portion is configured to adjustably support the infrared thermocouple at a plurality of first predetermined distances above the floor of the oven cavity when the base rests on the floor.

In an example, the body includes a contact surface configured to abut a sidewall of the oven cavity, wherein the support portion is configured to support the infrared thermocouple at a second predetermined distance away from the sidewall of the oven cavity when the contact surface abuts the sidewall of the oven cavity. In other examples, the support portion is configured to adjustably support the infrared thermocouple at a plurality of second predetermined distances away from the sidewall of the oven cavity when the contact surface abuts the sidewall of the oven cavity.

In some examples, at least a part of the jig is magnetic. Particularly, in an example at least a part of the base is magnetic. In another example, at least a part of the contact surface is magnetic.

In an example, the system can include an input device in communication with the control unit, the input device configured to receive an input from an operator to start a timer corresponding to an initiation of a gas flow to the gas burner of the gas household cooking appliance. The system can include a display in communication with the control unit, in which the display is configured to display the timer to the operator. The display can be configured to display to the operator that the output signal has been received by the control unit from the infrared thermocouple indicating that the change in temperature was detected by the infrared thermocouple within the oven cavity within the predetermined amount of time following the initiation of the gas flow.

Another exemplary embodiment of the invention is directed to a method of confirming that a gas burner has ignited for a testing operation of a gas household cooking appliance having an oven cavity and said gas burner within said oven cavity. The method includes a step of temporarily positioning an infrared thermocouple within the oven cavity prior to commencement of the testing operation, the infrared thermocouple being in communication with a control unit of a test system, the infrared thermocouple configured to produce an output signal in response to a change in temperature within the oven cavity associated with an ignition of the gas burner, a step of initiating a timer on the test system corresponding to an initiation of a gas flow to the gas burner of the gas household cooking appliance, and a step of executing, by the control unit, the testing operation only upon receipt of the output signal from the infrared thermocouple within a predetermined amount of time following the initiation of the timer.

In an example, the method further includes a step of mounting the infrared thermocouple on a jig and temporarily positioning the infrared thermocouple within the oven cavity by positioning the jig on a floor of the oven cavity. In this example, the jig is configured to support the infrared thermocouple at a first predetermined distance above the floor of the oven cavity and at a second predetermined distance away from a sidewall of the oven cavity. The jig can be magnetically coupled to the floor of the oven cavity and/or magnetically coupled to the sidewall of the oven cavity.

The gas household cooking appliance to be tested can include a standalone appliance, wall mounted appliance, such as a stand-alone oven, wall mounted oven, double oven, combination oven, countertop oven, or a freestanding range having one or more gas cooking or warming devices, such as an oven, steam oven, convection oven, and/or warming drawer. The system according to the present invention can be simply and easily moved from one appliance to another, including from one type of appliance to another type of appliance, by an operator/tester to perform testing operations. According to the present invention, the infrared thermocouple can be accurately and reliably positioned, with little effort by an operator/tester, with respect to one or more of a floor surface or a wall surface of the oven cavity. If desired, the position of the infrared thermocouple with respect to one or more of a floor or a wall of the oven cavity can be easily adjusted depending on the arrangement or type of gas cooking appliance, thereby improving reliability of the testing procedure and test results for different arrangements or types of gas cooking appliances. A position of the infrared thermocouple can be temporarily and removably fixed in position within the oven cavity by one or more magnetic portions of the jig supporting the infrared thermocouple, thereby improving reliability of the testing procedure and test results. In this way, the present invention also can minimize the complexity of a set up for testing operations and reduce an amount of time required for set up and testing of an appliance.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a schematic view of a system for performing a test operation of a gas household cooking appliance, according to an exemplary embodiment of the invention;

FIG. 2 is a schematic perspective top view of a jig for temporarily supporting and positioning an infrared thermocouple in a household gas cooking appliance for oven testing purposes, according to an exemplary embodiment of the invention;

FIG. 3 is a schematic side view of the exemplary jig illustrated in FIG. 2, according to an exemplary embodiment of the invention;

FIG. 4 is a schematic top view of the exemplary jig illustrated in FIG. 2, according to an exemplary embodiment of the invention;

FIG. 5 is a schematic perspective bottom view of the exemplary jig illustrated in FIG. 2, according to an exemplary embodiment of the invention;

FIG. 6 is a schematic side view of an assembled jig and infrared thermocouple of a system for performing a test operation of a gas household cooking appliance, according to an exemplary embodiment of the invention;

FIG. 7 is a schematic view of a system for performing a test operation of a gas household cooking appliance, according to an exemplary embodiment of the invention;

FIG. 8 is another schematic view of a system for performing a test operation of a gas household cooking appliance, according to an exemplary embodiment of the invention;

FIG. 9 is a schematic partial side view of an oven cavity of a gas household cooking appliance having an assembled jig and infrared thermocouple of a system for performing a test operation of the gas household cooking appliance, according to an exemplary embodiment of the invention; and

FIG. 10 is a flow chart illustrating a method of performing a test operation of a gas household cooking appliance, according to an exemplary embodiment of the invention, according to another exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

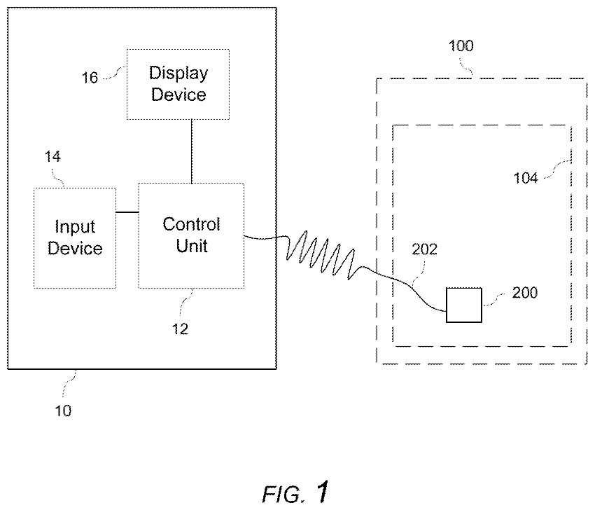

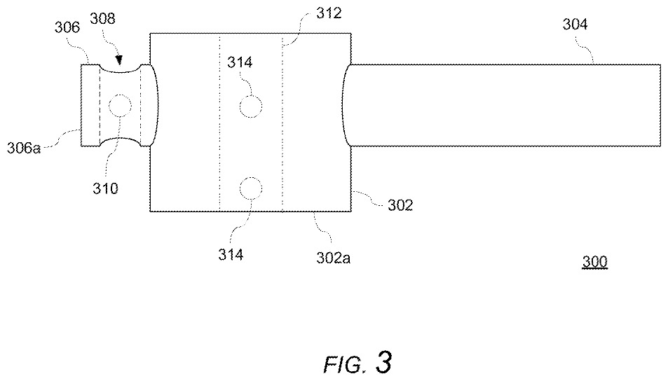

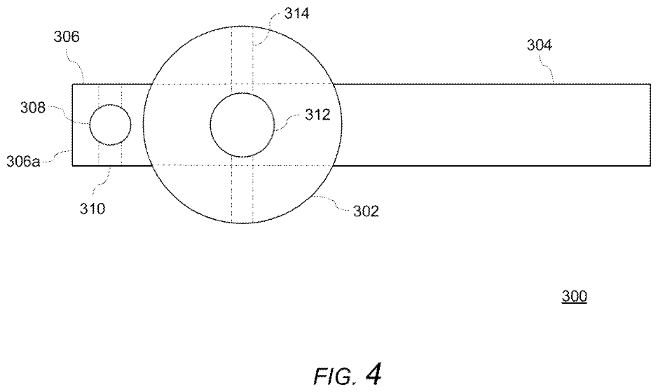

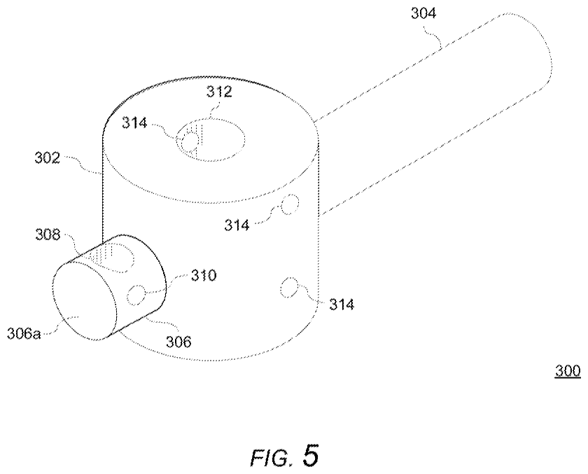

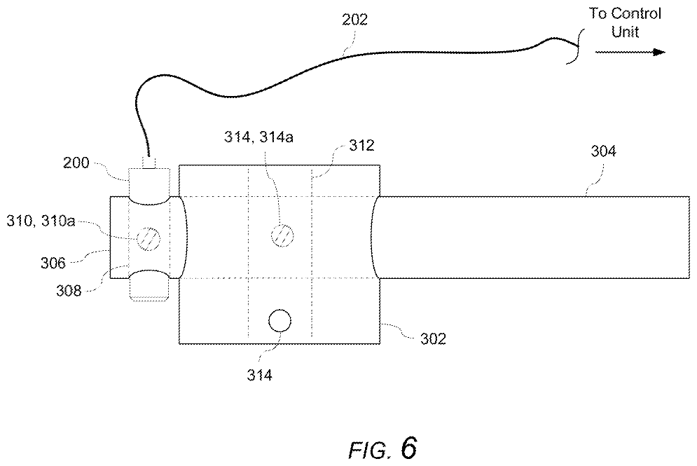

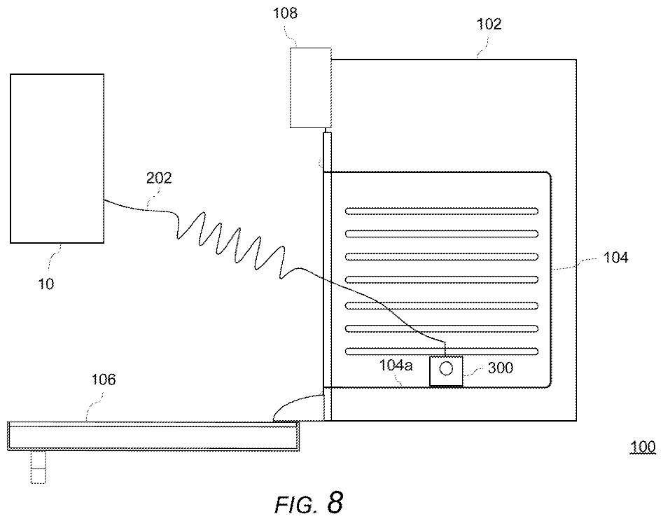

Referring now to the drawings, FIGS. 1-10 illustrate exemplary embodiments of a system for, and method of, confirming that a gas burner of a gas cooking appliance has ignited prior to executing a test operation of a gas household cooking appliance to be tested, for example, for compliance with industry standards or regulations related to testing, inspection, and certification. Like reference numerals are used to identify similar features of the example embodiments in FIGS. 1-10.

The gas household cooking appliance 100 to be tested can include, for example, a standalone appliance, wall mounted appliance, such as a stand-alone oven, wall mounted oven, double oven, combination oven, countertop oven, or a freestanding range having one or more gas cooking or warming devices, such as an oven, steam oven, convection oven, and/or warming drawer. With reference to FIGS. 1, 7, and 8, an example of a household cooking appliance 100 can include, for example, a housing 102 having an oven cavity 104 accessible through an opening, an oven door 106 covering the opening and moveable about a hinge between an open position and a closed position, and a control panel 108 having a user input device for controlling operation of one or more gas burners, circulating fans, etc. in the oven cavity 104 for performing a preheat operation, cooking operation, warming operation, etc. The user input device 108 can include one or more control knobs, touch sensitive input devices, etc. for controlling operation of the appliance 100. One or more oven racks (not shown) or other support devices can be provided within the oven cavity 104. One of ordinary skill will recognize that other configurations are possible.

With reference to FIG. 1, an example embodiment of a test system 10 for confirming that a gas burner of a gas cooking appliance 100 has ignited prior to executing a test operation of the gas household cooking appliance 100, will now be described.

The test system 10 can include, for example, a control unit 12, one or more input devices 14, and a display device 16. The control unit 12 can be configured to, for example, receive operator or user inputs, receive external data associated with one or more test operation, receive and/or analyze signals from one or more sensors, meters, or other instruments, such as an infrared thermocouple or thermocouple indicator, monitor or execute one or more timing operations, monitor or execute one or more test operations or functions, and/or output or display test data or test results, among other things. One of ordinary skill in the art will recognize that the control unit 12 can include, for example, memory configured to be read and/or written to by way of, for example, a microcontroller, among other components. One or more programs for controlling the system 10 and/or components thereof, one or more testing operations, additional testing operations, communication with one or more testing devices, communication with one or more appliances, etc. may be stored in the memory unit, along with, for example, data representing predetermined data, test data, test results, test criteria, etc. The control unit 12 can be configured to execute one or more of such programs and/or to permit the execution of, or deny the execution of, one or more of such programs by the system 10 and/or one or more programs executed by an external testing system in communication with the system 10.

The input device 14 can include, for example, one or more of control knobs, touch sensitive input devices, keyboard, keypad, etc. for controlling operation of the components and functionality of the test system 10. The input device 14 can be integrally formed with, or in communication with, the control unit 12. The input device 14 can be configured to receive an input from an operator to start a timer corresponding to an initiation of a gas flow to the gas burner of the gas household cooking appliance 100. The display device 16 can be, for example, a separate display, such as a display monitor, or integrally formed with the input device 14 and/or the control unit 12, such as a touch screen, notebook computer, etc. The display 16 can be configured to display the timer to the operator.

The system 10 can include at least one infrared thermocouple 200 configured to be portably and temporarily positioned within the oven cavity 104 of a gas household cooking appliance 100 to be tested, for example, for compliance with industry standards or regulations related to testing, inspection, and certification. The infrared thermocouple 200 can be configured to produce an output signal in response to a change in temperature within the oven cavity 104 to thereby confirm that a gas burner has ignited. In operation, the infrared thermocouple 200 can be configured to produce an output signal in response to a change in temperature within such a predetermined amount of time, for example, such as within seconds of a change in temperature, within milliseconds of a change of temperature, etc. One of ordinary skill in the art will recognize that the infrared thermocouple 200 is not limited to any particular thermocouple, and any a suitable thermocouple, such as a non-contact infrared thermocouple, can be selected, for example, based on the desired accuracy, temperature range, and/or compatibility or interfacing with testing devices or instrumentation, among other things, such as infrared thermocouple Omega™ Model OS36-J-140F, or the like.

The control unit 12 can be arranged to communicate with the infrared thermocouple 200 to be capable of receiving an output signal from the infrared thermocouple 200 in response to a change in temperature detected by the infrared thermocouple 200 within the oven cavity 104. The control unit 12 can be configured to interpret or process the output signal to thereby confirm whether a gas burner of the gas household cooking appliance 100 has ignited. The display 16 can be configured to display to the operator that the output signal has been received by the control unit 12 from the infrared thermocouple 200 indicating that the change in temperature was detected by the infrared thermocouple 200 within the oven cavity 104.

The control unit 12 can be configured to execute, or permit the execution of, a test operation only upon receipt of the output signal from the infrared thermocouple 200 following an initiation of a gas flow to the gas burner. In other words, the control unit 12 can be configured to prohibit the execution of a testing operation until an output signal is received from the infrared thermocouple 200 representing a change in temperature in the oven cavity 104, thereby confirming that the burner has ignited (i.e., the burner flame has been lighted).

In an example, the control unit 12 can be configured to execute, or permit the execution of, the test operation only upon receipt of the output signal from the infrared thermocouple 200 within a predetermined amount of time following the initiation of a gas flow to the gas burner. In other words, even if an output signal is received from the infrared thermocouple 200 representing a change in temperature in the oven cavity 104, the control unit 12 can be configured to prohibit the execution of a testing operation if the output signal from the infrared thermocouple 200 is not received within a predetermined amount of time following the initiation of a gas flow to the gas burner. As explained above, the input device 14 can be configured, for example, to receive an input from an operator to start a timer corresponding to an initiation of a gas flow to the gas burner of the gas household cooking appliance 100. The control unit 12 can be configured, for example, to provide a timer or timer function to determine an amount of time elapsed following the initiation of the gas flow to the gas burner, or following the input from an operator indicating that the gas flow to the gas burner has been initiated. The amount of elapsed time can be, for example, a specified standard period of time mandated by one or more industry standards or regulations related to testing, inspection, and certification, such as a period of several seconds.

With reference again to FIG. 1, the control unit 12 can be configured to communicate with the infrared thermocouple 200 via a wired connection, such as a wire harness 202 coupled between the control unit 12 and infrared thermocouple 200. The wire harness 202 can have a suitable connector configured to couple the wire harness 202 to the control unit 12, or to an intervening meter or indicator (not shown) configured to interface with the control unit 12 and provide an output signal representing a change in temperature in the oven cavity 104 to the control unit 12. The wire harness 202 can have a suitable length and configuration to permit the infrared thermocouple 200 to be portably and temporarily positioned in an appliance to be tested, or to be moved from one appliance being tested to another appliance to be tested.

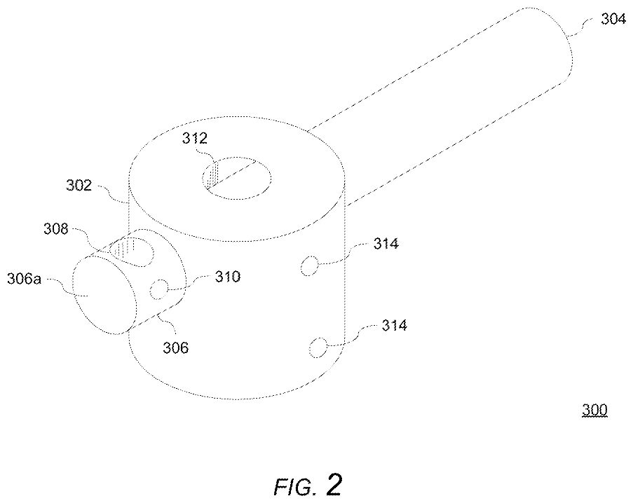

With reference to FIGS. 2-6, an exemplary embodiment of the test system 10 can include a jig 300 or the like configured to portably and temporarily support the infrared thermocouple 200 within the oven cavity 104. The jig 300 can be configured to support the infrared thermocouple 200 at a predetermined distance above a floor 104a of the oven cavity 104 and at a predetermined distance away from a sidewall 104b of the oven cavity 104.

In the exemplary embodiment illustrated in FIGS. 2-6, a jig 300 can include a body 302 having a base 302a configured to rest on a floor 104a of the oven cavity 104. The jig 300 can include a handle 304 extending from the body 302 such that the jig 300 can be easily grasped, moved, and/or positioned by an operator/user in order to position the infrared thermocouple 200 for testing. The body 302 can include a support portion 306 configured to support the infrared thermocouple 200 at a predetermined distance above the floor 104a of the oven cavity 104 when the base 302a rests on the floor 104a. The components of the jig 300 can be integrally formed or formed from separate components. In the example shown in FIGS. 2-6, the jig 300 includes an element (e.g., a cylindrical element) extending through openings formed in the body 302 such that a first portion of the element on one side of the body 302 forms the handle 304 and a second portion of the element on the other side of the body 302 forms the support portion 306.

The support portion 306 can include an opening or through hole 308 configured to receive and support the infrared thermocouple 200 at a predetermined distance above a floor 104a of the oven cavity 104 and at a predetermined distance away from a sidewall 104b of the oven cavity 104. The support portion 306 can include an opening 310 configured to receive a fixation element 310a, such as a set screw or the like, to secure the infrared thermocouple 200 in the opening or through hole 308. In an example embodiment, the support portion 306 can be configured to adjustably support the infrared thermocouple 200 at one or more different distances or heights above the floor of the oven cavity when the base rests on the floor. For example, the infrared thermocouple 200 can be moveable within the opening 308 such that the infrared thermocouple 200 can be positioned at a desired height within the opening 308 and fixed in the desired height position using the fixation element 310a extending through opening 310 in the support portion 306. Other arrangements of the body 302 and/or support portion 306 are possible for receiving and supporting the infrared thermocouple 200 at a predetermined distance above the floor 104a when the base 302a rests on the floor 104a of the oven cavity 104.

In the example shown in FIGS. 2-6, the support portion 306 can include a contact surface 306a configured to abut a sidewall 104b of the oven cavity 104, which thereby positions and supports the infrared thermocouple 200 at a predetermined distance away from the sidewall 104b of the oven cavity 104 when the contact surface 306a is abutting the sidewall 104b. In an example, the support portion 306 can be configured to adjustably support the infrared thermocouple 200 at one or more different distances away from the sidewall 104b of the oven cavity 104 when the contact surface 306a abuts the sidewall 104b.

In other exemplary embodiments, at least a part of the jig 300 can be magnetic such that one or more parts of the jig 300 can be magnetically coupled to a floor 104a of the oven cavity 104 and/or a sidewall 104b of the oven cavity 104 in order to temporarily (i.e., removably) fix a position of the jig 300 within the oven cavity 104. For example, in the illustrated example shown in FIGS. 2-6, the base 302a can be magnetic such that the jig 300 can be magnetically coupled to the floor 104a of the oven cavity 104 and/or the support 306a can be magnetic such that the jig 300 can be magnetically coupled to the sidewall 104b of the oven cavity 104 in order to temporarily (i.e., removably) secure the jig 300 in a fixed position with respect to the floor 104a and/or wall 104b.

In the example shown in FIGS. 2-6, the body 302 can include one or more additional openings. For example, one or more openings (e.g., 312, 314) can be provided to reduce a weight of the jig 300 (e.g., 312), receive and support other components such as the handle 304 and support portion 306, receive one or more fixation elements (e.g., 314a) to secure other components such as the handle 304 and support portion 306 to the body 302, and/or permit airflow through the body 302, etc.

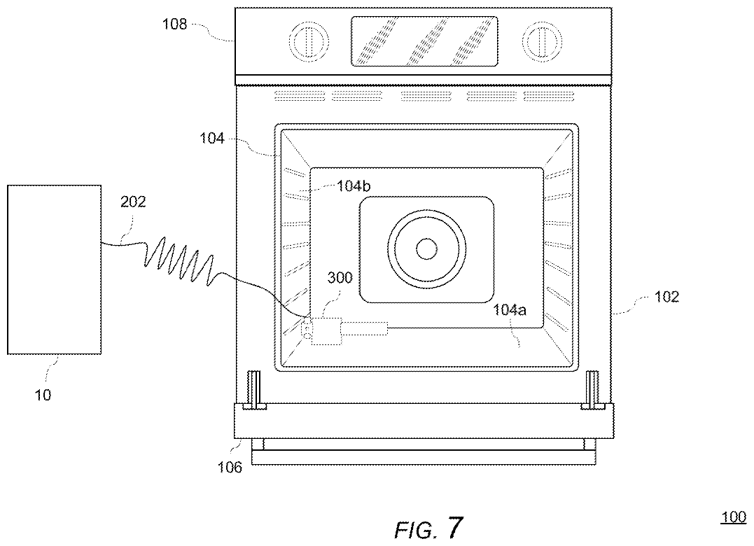

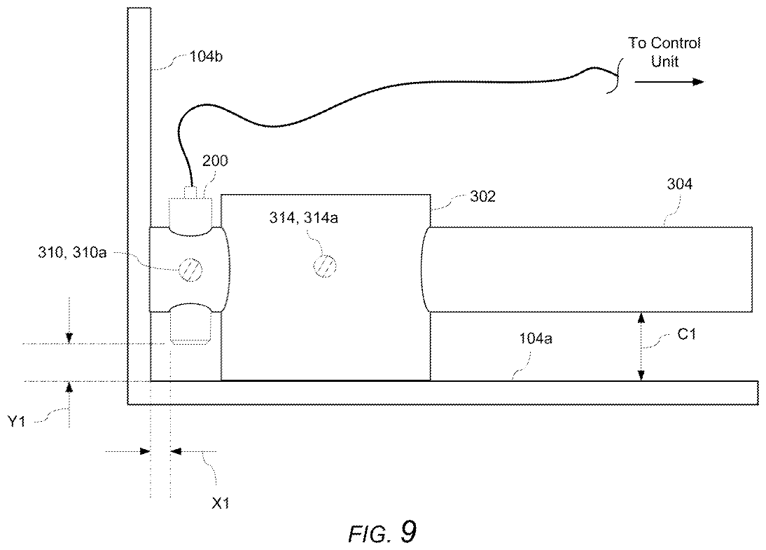

FIGS. 7-9 show an example of a test system 10 having an infrared thermocouple 200 disposed within an oven cavity 104 and supported by a jig 300 in accordance with embodiments of the invention. In this example, the infrared thermocouple 200 is disposed within an opening 308 of the support portion 306 of the jig 300 at a desired height and secured in place by a fixation element 310a extending through opening 310 in the support portion 306. In this example, the jig 300 can be positioned on the floor 104a of the oven cavity 104 with the contact surface 306a of the jig 300 abutting a sidewall 104b of the oven cavity. As a result, the jig 300 supports the infrared thermocouple 200 at a predetermined distance Y1 above the floor 104a and at a predetermined distance X1 away from the sidewall 104b, as shown in FIG. 9. The jig 300 is configured such that a suitable clearance C1 exists between the handle 304 and the floor 104a to enable an operator to grasp the handle for positioning or repositioning the jig 300 on the floor 104a or removing the jig 300 from the floor 104a.

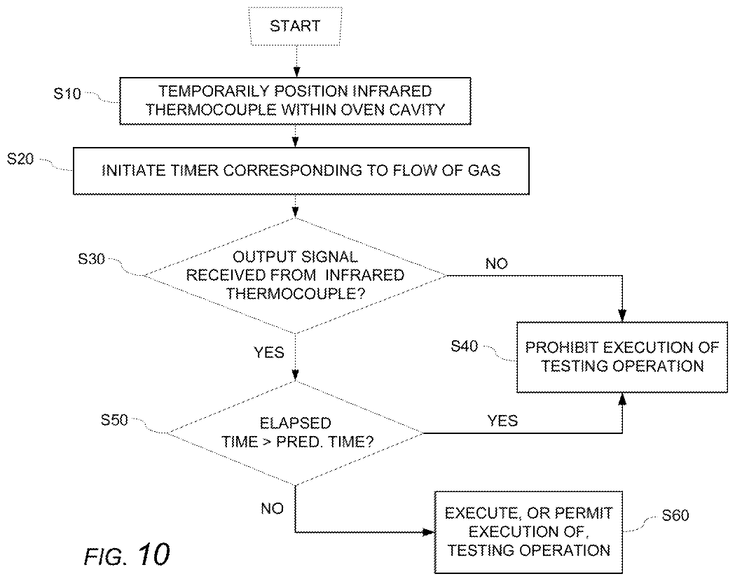

FIG. 10 shows an example of a method of confirming that a gas burner has ignited prior to executing a test operation of a gas household cooking appliance to be subject to additional testing, for example, for compliance with industry standards or regulations related to testing, inspection, and certification, in accordance with embodiments of the invention. In operation, an operator temporarily positions an infrared thermocouple 200 within the oven cavity 104 prior to commencement of a testing operation, as shown in Step S10. The operator then turns on a gas flow to the gas burner of the gas household cooking appliance 100 and initiates a timer on the test system 10, or the like, corresponding to the start of the gas flow to the gas burner, as shown in Step S12.

In Step S30, the control unit 12 determines whether an output signal has been received from the infrared thermocouple 200. If an output signal has not been received from the infrared thermocouple 200, then the control unit 12 prohibits execution of the testing operation (i.e., the control unit 12 executes, or permits execution of, the testing operation only upon receipt of the output signal from the infrared thermocouple 200), as shown in Step S40.

In Step S50, if an output signal has been received from the infrared thermocouple 200, then the control unit 12 determines whether the output signal has been received from the infrared thermocouple 200 within a predetermined amount of time following the initiation of the timer in Step S20. If the output signal has not been received within the predetermined amount of time following the initiation of the timer in Step S20, then the control unit 12 prohibits execution of (i.e., does not execute or does not permit execution of) the testing operation, as shown in Step S40.

If the output signal has been received within the predetermined amount of time following the initiation of the timer in Step S20, then the control unit 12 permits execution of, or executes, the testing operation, as shown in Step S60.

With reference again to Step S10, in another example, an operator mounts the infrared thermocouple 200 on a jig 300 and then temporarily positions the jig 300 and infrared thermocouple 200 within the oven cavity 104 by positioning the jig 300 on the floor 104a, for example, such that the infrared thermocouple 200 is disposed at a first predetermined distance above the floor 104a and at a second predetermined distance away from the sidewall 104b, prior to commencement of the testing operation.

According to the exemplary embodiments, the present invention provides a system for, and method of, confirming that a gas burner of a gas cooking appliance has ignited prior to executing a test operation of a gas household cooking appliance, for example, for compliance with industry standards or regulations related to testing, inspection, and certification, and executing the test operation only upon confirming that the gas burner has ignited within a predetermined amount of time following an initiation of a gas flow to the gas burner. In other words, the system and method can be configured to suspend or prevent (e.g., automatically suspend or prevent) any further test operations from proceeding in stances in which ignition of the gas burner has not occurred within a predetermined amount of time following an initiation of a gas flow to the gas burner. In this way, the exemplary embodiments of the present invention can eliminate a need for an operator/tester to physically inspect or view the flame to determine whether the oven burner has ignited and ensure that a burner of the gas cooking appliance has ignited within a predetermined time defined by one or more specified industry standards or regulations related to testing, inspection, and certification, thereby improving reliability and repeatability of the testing procedures and test results.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A system for performing a test operation of a gas household cooking appliance having an oven cavity and a gas burner within the oven cavity, the system comprising:
an infrared thermocouple configured to be portably and temporarily positioned within the oven cavity, the infrared thermocouple configured to produce an output signal in response to a change in temperature within the oven cavity to thereby confirm that the gas burner has ignited; and
a control unit in communication with the infrared thermocouple, the control unit configured to execute the test operation only upon receipt of the output signal from the infrared thermocouple within a predetermined amount of time following an initiation of a gas flow to the gas burner.

2. The system of claim 1, further comprising:
a jig configured to portably and temporarily support the infrared thermocouple within the oven cavity.

3. The system of claim 2, wherein the jig is configured to support the infrared thermocouple at a first predetermined distance above a floor of the oven cavity and at a second predetermined distance away from a sidewall of the oven cavity.

4. The system of claim 3, wherein at least a part of the jig is magnetic.

5. The system of claim 2, wherein the jig comprises:
a body; and
a handle extending from the body.

6. The system of claim 5, wherein the body comprises:
a base configured to rest on a floor of the oven cavity; and
a support portion configured to support the infrared thermocouple at a first predetermined distance above the floor of the oven cavity when the base rests on the floor.

7. The system of claim 6, wherein the support portion is configured to adjustably support the infrared thermocouple at a plurality of first predetermined distances above the floor of the oven cavity when the base rests on the floor.

8. The system of claim 6, wherein the body includes a contact surface configured to abut a sidewall of the oven cavity,
wherein the support portion is configured to support the infrared thermocouple at a second predetermined distance away from the sidewall of the oven cavity when the contact surface abuts the sidewall of the oven cavity.

9. The system of claim 8, wherein the support portion is configured to adjustably support the infrared thermocouple at a plurality of second predetermined distances away from the sidewall of the oven cavity when the contact surface abuts the sidewall of the oven cavity.

10. The system of claim 6, wherein at least a part of the base is magnetic.

11. The system of claim 8, wherein at least a part of the contact surface is magnetic.

12. The system of claim 1, further comprising:
an input device in communication with the control unit, the input device configured to receive an input from an operator to start a timer corresponding to an initiation of a gas flow to the gas burner of the gas household cooking appliance.

13. The system of claim 12, further comprising:
a display in communication with the control unit, the display configured to display the timer to the operator.

14. The system of claim 13, wherein the display is configured to display to the operator that the output signal has been received by the control unit from the infrared thermocouple indicating that the change in temperature was detected by the infrared thermocouple within the oven cavity within the predetermined amount of time following the initiation of the gas flow.

15. A method of confirming that a gas burner has ignited for a testing operation of a gas household cooking appliance having an oven cavity and said gas burner within said oven cavity, the method comprising:
temporarily positioning an infrared thermocouple within the oven cavity prior to commencement of the testing operation, the infrared thermocouple being in communication with a control unit of a test system, the infrared thermocouple configured to produce an output signal in response to a change in temperature within the oven cavity associated with an ignition of the gas burner;
initiating a timer on the test system corresponding to an initiation of a gas flow to the gas burner of the gas household cooking appliance; and
executing, by the control unit, the testing operation only upon receipt of the output signal from the infrared thermocouple within a predetermined amount of time following the initiation of the timer.

16. The method of claim 15, further comprising:
mounting the infrared thermocouple on a jig and temporarily positioning the infrared thermocouple within the oven cavity by positioning the jig on a floor of the oven cavity.

17. The method of claim 16, wherein the jig is configured to support the infrared thermocouple at a first predetermined distance above the floor of the oven cavity and at a second predetermined distance away from a sidewall of the oven cavity.

18. The method of claim 16, wherein the jig is magnetically coupled to the floor of the oven cavity.

19. The method of claim 16, wherein the jig is magnetically coupled to the sidewall of the oven cavity.
